(19) United States
(12) Patent Application Publication
(10) Pub. No.: US 2015/0097461 A1
(43) Pub. Date: Apr. 9, 2015

(54) Rotating Electrical Machine

(71) Applicant: CONTINENTAL AUTOMOTIVE GMBH, Hannover (DE)

(72) Inventor: Michael Bulatow, Berlin (DE)

(21) Appl. No.: 14/381,654

(22) PCT Filed: Feb. 26, 2013
(86) PCT No.: PCT/EP2013/053802

§ 371 Date: Aug. 28, 2014

(30) Foreign Application Priority Data
Feb. 28, 2012 (DE) 20 2012 002 027.7

(51) Int. Cl. H02K 11/00; H02K 1/22

(52) U.S. Cl. CPC H02K 11/0015; H02K 1/22
USPC 310/216.004

(57) ABSTRACT

A rotary electric machine may include a rotor that includes a laminated core arranged on a rotor shaft, wherein the rotor has at least one end-winding cover that encloses the laminated core in the axial direction of the rotor shaft, and the end-winding cover has an outer face, and a sensor track of a sensor is arranged on the outer face of the end-winding cover.

### CROSS-REFERENCE TO RELATED APPLICATIONS

This application is a U.S. National Stage Application of International Application No. PCT/EP2013/053802 filed Feb. 26, 2013, which designates the United States of America, and claims priority to DE Application No. 20 2012 002 027.7 filed Feb. 28, 2012, the contents of which are hereby incorporated by reference in their entirety.

### TECHNICAL FIELD

The present invention relates to a rotating electrical machine, in particular an electric motor or a generator. Furthermore, a method for producing a rotating electrical machine is disclosed.

### BACKGROUND

Electric motors are increasingly being fitted in modern motor vehicles. They are used in particular as drive motors that are fully integrated in the drive train or in hybrid applications, for example also as starter generators. This involves sometimes using separately excited synchronous machines that have a rotor comprising a laminated core provided with an excitation winding.

To control the electric motor, such electric or hybrid vehicles are often fitted with angle-of-rotation sensors or rotor position sensors (abbreviated as RPSs), which sense the rotational speed or angle of rotation or rotor position and are usually formed as inductive sensors. Such a sensor receives a signal from a sensor wheel that is fastened to the rotor and rotates along with it.

DE 10 2005 062 865 A1 discloses such a sensor, in which the sensor is axially opposite the sensor track arranged on a co-rotating sensor wheel. However, such an arrangement comprises a large number of individual components, such as spacer elements, retaining elements and the sensor wheel, which are respectively accompanied by production and installation tolerances.

### SUMMARY

One embodiment provides a rotating electrical machine including a rotor comprising a laminated rotor core arranged on a rotor shaft; the rotor having at least one end-winding cover that closes off the laminated rotor core in the axial direction of the rotor shaft; the end-winding cover having an outer side; and a sensor track of a sensor being arranged on the outer side of the end-winding cover.

In a further embodiment, the sensor track is arranged on an end face of the end-winding cover that closes off the laminated rotor core in the axial direction.

In a further embodiment, the sensor track is arranged on a side face of the end-winding cover that closes off the laminated rotor core in the radial direction.

In a further embodiment, the sensor track is applied on the outer side of the end-winding cover by the cold gas spraying process.

In a further embodiment, the sensor track contains copper, aluminum and/or steel.

In a further embodiment, the sensor track is stamped in on the outer side of the end-winding cover during a deep-drawing process.

In a further embodiment, the end-winding cover comprises an alloy containing iron, chromium and nickel, chromium being contained in the alloy with a percentage by weight of between 18 and 19 and nickel being contained in the alloy with a percentage by weight of between 12 and 13.

In a further embodiment, the end-winding cover comprises an alloy composition Fe_{remainder}CrₐNi_{b}Mn_{c}C_{d}SiₑP_{f}S_{g}Nₕ, in which a, b, c, d, e, f, g and h are given in percent by weight and 18≦a≦19; 12≦b≦13; 0≦c≦1.4; 0≦d≦0.055; 0≦e≦0.6; 0≦f≦0.04; 0≦g≦0.008 and 0≦h≦0.1.

Another embodiment provides a motor vehicle including a rotating electrical machine as disclosed above.

### BRIEF DESCRIPTION OF THE DRAWINGS

Example embodiments of the invention are explained in more detail below with reference to the drawings, in which:

FIG. 1 schematically shows a section through a part of a rotor of a rotating electrical machine according to one embodiment;

FIG. 2 schematically shows a perspective view of the rotor according to FIG. 1;

FIG. 3 schematically shows a section through a part of an end-winding cover according to a first embodiment; and

FIG. 4 schematically shows a section through a part of an end-winding cover according to a second embodiment.

### DETAILED DESCRIPTION

Embodiments of the invention provide a rotating electrical machine that is of the simplest possible construction, is at the same time robust and has a rotor position sensor.

Furthermore, an economical method for producing such a rotating electrical machine is to be provided.

According to one aspect of the invention, a rotating electrical machine that has a rotor with a laminated rotor core arranged on a rotor shaft is provided. The rotor has at least one end-winding cover that closes off the laminated rotor core in the axial direction of the rotor shaft, the end-winding cover having an inner side and an outer side. Arranged on the outer side of the end-winding cover is a sensor track of a sensor. The laminated rotor core preferably has in this case an excitation winding.

This rotating electrical machine has relatively few components, since a separate sensor wheel is not provided for the sensor. Rather, the sensor track is applied to the end-winding cover itself, which is in any case present on such machines with excitation windings and possibly filled rotor slots.

In one embodiment, the sensor track is arranged on an end face of the end-winding cover that closes off the laminated rotor core in the axial direction. This embodiment is suitable if a sensor element tracing the sensor track in the axial direction is to be provided.

In an alternative embodiment, the sensor track is arranged on a side face of the end-winding cover that closes off the laminated rotor core in the radial direction. This embodiment is suitable if a sensor element tracing the sensor track in the radial direction is to be provided.

In one embodiment, the sensor track is applied by the cold gas spraying process. In the case of this coating process, the coating material is applied in powder form to a substrate at high speed. The powder particles are thereby accelerated to such a high speed that they form a dense and firmly adhering layer on impact with the substrate, even without previously being partially or fully melted.

Various materials are suitable for the sensor track applied by the cold gas spraying process. It may in particular comprise a material that is selected from the group copper, aluminum and steel.

In an alternative embodiment, the sensor track is stamped in during a deep-drawing process. If the end-winding cover is produced by the deep-drawing process, the sensor track can be produced at the same time without great additional effort. For this purpose, the contour of the sensor track is stamped through onto the outer side of the end-winding cover.

In the case of this embodiment, the sensor track is consequently formed from the same material as the end-winding cover and as one part with the end-winding cover.

In one embodiment, the end-winding cover comprises an alloy, the alloy containing iron, chromium and nickel, chromium being contained in the alloy with a percentage by weight of between 18 and 19 (that is to say 18% to 19%) and nickel being contained in the alloy with a percentage by weight of between 12 and 13 (that is to say 12% to 13%).

For example, the end-winding cover comprises a material that substantially comprises the alloy composition Fe_{remainder}CrₐNi_{b}Mn_{c}C_{d}SiₑP_{f}S_{g}Nₕ, that is to say an alloy composition containing:
chromium Cr with a percentage by weight a of between 18 and 19,
nickel Ni with a percentage by weight b of between 12 and 13,
manganese Mn with a percentage by weight c of between 0 and 1.4,
carbon C with a percentage by weight d of between 0 and 0.055,
silicon Si with a percentage by weight e of between 0 and 0.6,
phosphorus P with a percentage by weight f of between 0 and 0.04,
sulfur S with a percentage by weight g of between 0 and 0.008,
nitrogen N with a percentage by weight h of between 0 and 0.1,
iron Fe with the remaining percentage by weight remainder,
where preferably or ideally:
   the remainder=100−a−b−c−d−e−f−g−h. In addition, the material may comprise impurities of other substances that are typical in production.

As compared with known stainless steels, for example the steels 1.4301 or 1.4303 conforming to European standard EN 10020, this material has a particularly high proportion of chromium and nickel. It has been found that workpieces made of this steel remain unmagnetizable even after forming, punching or cutting. Eddy current losses are consequently reduced. This steel is therefore particularly suitable for the end-winding cover on account of its strength and its unmagnetizability.

Such a rotating electrical machine is also suitable for high rotational speeds of 10 000 revolutions per minute and more.

In one embodiment, the rotating electrical machine is formed as an electric motor. It may also be formed as a generator, for example as a starter generator, or be capable of operating both as a motor and as a generator.

Such electric motors are suitable for use in a motor vehicle. They may be used both as drive motors that are fully integrated in the drive train, for example as wheel-hub or axle motors, and for example as starter generators. According to one aspect of the invention, a motor vehicle that has the electric motor described is therefore provided. The motor vehicle may in this case be formed as an electric or hybrid vehicle.

Furthermore, a method for producing a rotating electrical machine is provided, the method comprising the following:
providing a laminated rotor core with an excitation winding;
providing an end-winding cover that is suitable for closing off the laminated rotor core in the axial direction, and has an inner side and an outer side;
applying a sensor track of a sensor to the outer side of the end-winding cover.

The application of the sensor track may take place in particular by the cold gas spraying process. It is also conceivable to apply the sensor track in some other way on the outer side of the end-winding cover. For example, the sensor track may be prefabricated from aluminum, high-grade steel or copper or alloys thereof and be connected to the end-winding cover by means of a connecting process, such as for example spot welding, friction welding, riveting, screwing, calking or adhesive bonding.

Furthermore, a further method for producing a rotating electrical machine is provided, the method comprising the following:
providing a laminated rotor core with an excitation winding,
producing an end-winding cover by the deep-drawing process, the end-winding cover being suitable for closing off the laminated rotor core in the axial direction, and the end-winding cover having an end face that closes off the laminated rotor core in the axial direction;
stamping through a sensor track of a sensor onto the end face of the end-winding cover during the deep-drawing process.

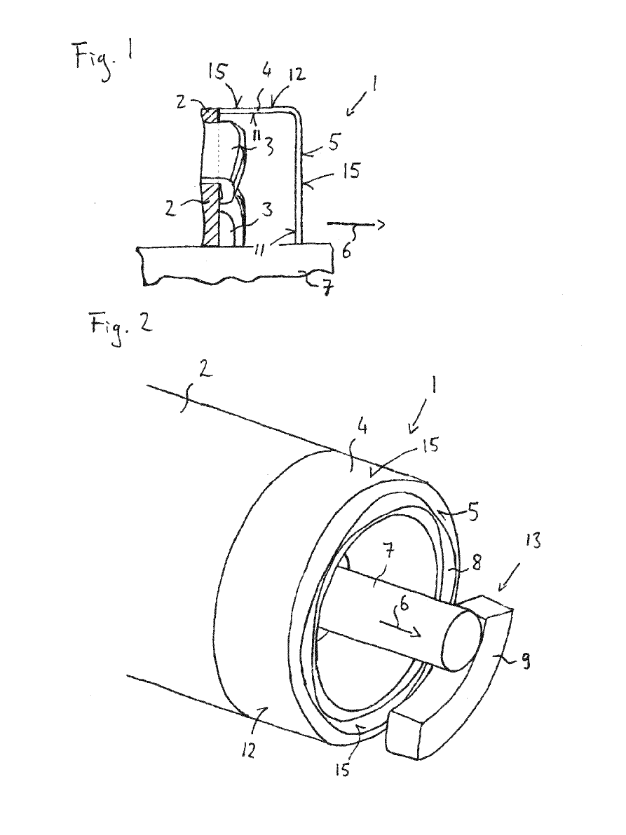

FIG. 1 shows a section through a part of a rotor 1 of a rotating electrical machine. The stator is not shown.

In this embodiment, the rotating electrical machine is formed as a separately excited synchronous machine. Its rotor 1 has a laminated rotor core 2 with an excitation winding 3. The excitation winding 3 is accommodated in slots of the laminated rotor core 2 that are not shown; the interior space of the slots may otherwise be filled with a sealing compound or impregnating resin.

In the region of the end windings of the excitation winding 3, an end-winding cover 4 is provided. This surrounds the end of the laminated rotor core 2 and the end windings of the excitation winding 3 and has a central opening for leading through the rotor shaft 7.

The end-winding cover 4 closes off the laminated rotor core 2 in the axial direction indicated by the arrow 6. It has an inner side 11, facing the laminated rotor core 2, and an outer side 15, facing away from the laminated rotor core 2. The outer side 15 is divided into an end face 5 that closes off the laminated rotor core 2 in the axial direction and an end face 12 that laterally surrounds, and consequently closes off, the laminated rotor core 2 in the radial direction.

FIG. 2 shows a perspective view of the rotor 1 according to FIG. 1. Also shown in this view is the rotor shaft 7, to which the laminated rotor core 2 is connected for rotation therewith and which is mounted rotatably on housing parts of the electrical machine that are not shown.

Also shown in FIG. 2 is a rotor position sensor 13 with a sensor element 9. Opposite the sensor element 9 in the axial direction, which is indicated by the arrow 6, is a sensor track 8, which is arranged on the end face 5 of the end-winding cover 4.

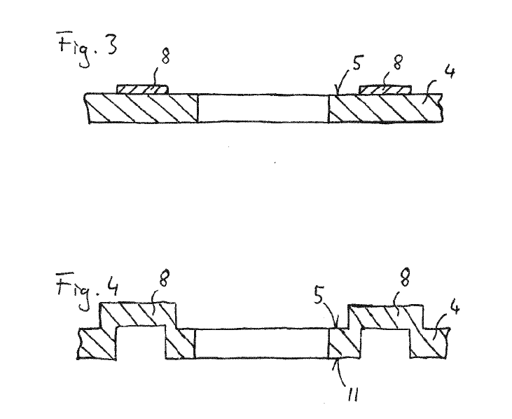

FIG. 3 shows a part of an end-winding cover 4 with the sensor track 8 according to a first embodiment in section. In the case of this embodiments, the sensor track 8 is applied to the end face 5 by the cold gas spraying process and consists of copper. It is also possible to use aluminum or steel or copper or aluminum alloys for the sensor track. The end-winding cover 4 consists of an unmagnetizable steel with the alloy composition Fe_{remainder}CrₐNi_{b}Mn_{c}C_{d}SiₑP_{f}S_{g}Nₕ, in which a, b, c, d, e, f, g and h are given in percent by weight and 18≦a≦19; 12≦b≦13; 0≦c≦1.4; 0≦d≦0.055; 0≦e≦0.6; 0≦f≦0.04; 0≦g≦0.008 and 0≦h≦0.1.

FIG. 4 shows a part of an end-winding cover 4 with the sensor track 8 according to a second embodiment in section. In the case of this embodiment, the sensor track 8 has been stamped through from the inner side 11 by the deep-drawing process in the production of the end-winding cover 4. In the case of this embodiment, the end-winding cover 4 and the sensor track 8 consist of the same material and are formed as one part. By the deep-drawing process, the sensor track 8 has been punched through on the outside 15 of the end-winding cover 4.

Although at least one embodiment has been given by way of example in the foregoing description, various changes and modifications can be made. The embodiments mentioned are merely examples and are not intended to restrict the scope of validity, the applicability or the configuration in any way. Rather, the foregoing description provides a person skilled in the art with a plan for implementing at least one exemplary embodiment, while numerous changes in the function and the arrangement of elements that are described in an exemplary embodiment can be made without departing from the scope of protection of the attached claims and their legal equivalents.

Furthermore, a method for producing a rotating electrical machine is disclosed, the method comprising the following:
providing a laminated rotor core 2 with an excitation winding 3;
providing an end-winding cover 4 that is suitable for closing off the laminated rotor core 2 in the axial direction, and has an inner side 11 and an outer side 15;
applying a sensor track 8 of a sensor 13 to the outer side 15 of the end-winding cover 4.

Moreover, a further method for producing a rotating electrical machine is disclosed, the method comprising the following:
providing a laminated rotor core 2 with an excitation winding 3,
producing an end-winding cover 4 by the deep-drawing process, the end-winding cover 4 being suitable for closing off the laminated rotor core 2 in the axial direction, and the end-winding cover 4 having an end face 5 that closes off the laminated rotor core 2 in the axial direction;
stamping through a sensor track 8 of a sensor 13 onto the end face 5 of the end-winding cover 4 during the deep-drawing process.

### LIST OF DESIGNATIONS

1 Rotor
2 Laminated rotor core
3 Excitation winding
4 End-winding cover
5 End face
6 Arrow
7 Rotor shaft
8 Sensor track
9 Sensor element
11 Inner side
12 Side face
13 Rotor position sensor
15 Outer side

What is claimed is:

1. A rotating electrical machine, comprising:
a rotor comprising a laminated rotor core arranged on a rotor shaft;
wherein the rotor includes at least one end-winding cover that closes off the laminated rotor core in an axial direction of the rotor shaft;
wherein the end-winding cover has an outer side; and
a sensor track of a sensor arranged on the outer side of the end-winding cover.

2. The rotating electrical machine of claim 1, wherein. the sensor track being is arranged on an end face of the end-winding cover that closes off the laminated rotor core in the axial direction.

3. The rotating electrical machine of claim 1, wherein the sensor track is arranged on a side face of the end-winding cover that closes off the laminated rotor core in the radial direction.

4. The rotating electrical machine of claim 1, wherein the sensor track is applied on the outer side of the end-winding cover by the cold gas spraying process.

5. The rotating electrical machine of claim 1, wherein the sensor track comprises at least one of copper, aluminum, and steel.

6. The rotating electrical machine of claim 1, wherein the sensor track is stamped in on the outer side (15) of the end-winding cover during a deep-drawing process.

7. The rotating electrical machine of claim 1, wherein the end-winding cover comprises an alloy containing iron, chromium and nickel, with the chromium in the alloy having a percentage by weight of between 18 and 19 and the nickel in the alloy having a percentage by weight of between 12 and 13.

8. The rotating electrical machine of claim 7, wherein. the end-winding cover comprises an alloy composition Fe_{remainder}CrₐNi_{b}Mn_{c}C_{d}SiₑP_{f}S_{g}Nₕ, in which a, b, c, d, e, f, g and h are given in percent by weight and 18≦a≦19; 12≦b≦13; 0≦c≦1.4; 0≦d≦0.055; 0≦e≦0.6; 0≦f≦0.04; 0≦g≦0.008; and 0≦h≦0.1.

9. A motor vehicle, comprising:
a rotating electrical machine comprising:
a roto comprising a laminated rotor core arranged on a rotor shaft;
wherein the rotor includes at least one end-winding cover that closes off the laminated rotor core in an axial direction of the rotor shaft;
wherein the end-winding cover has an outer side; and
a sensor track of a sensor arranged on the outer side of the end-winding cover.

10. The motor vehicle of claim 9, wherein the sensor track is arranged on an end face of the end-winding cover that closes off the laminated rotor core in the axial direction.

11. The motor vehicle of claim 9, wherein the sensor track is arranged on a side face of the end-winding cover that closes off the laminated rotor core in the radial direction.

12. The motor vehicle of claim 9, wherein the sensor track is applied on the outer side of the end-winding cover by the cold gas spraying process.

13. The motor vehicle of claim 9, wherein the sensor track comprises at least one of copper, aluminum, and steel.

14. The motor vehicle of claim 9, wherein the sensor track is stamped in on the outer side of the end-winding cover during a deep-drawing process.

15. The motor vehicle of claim 9, wherein the end-winding cover comprises an alloy containing iron, chromium and nickel, with the chromium in the alloy having a percentage by weight of between 18 and 19 and the nickel in the alloy having a percentage by weight of between 12 and 13.

16. The motor vehicle of claim 15, wherein the end-winding cover comprises an alloy composition Fe_{remainder}CrₐNi_{b}Mn_{c}C_{d}SiₑP_{f}S_{g}Nₕ, in which a, b, c, d, e, f, g and h are given in percent by weight and 18≦a≦19; 12≦b≦13; 0≦c≦1.4; 0≦d≦0.055; 0≦e≦0.6; 0≦f≦0.04; 0≦g≦0.008; and 0≦h≦0.1.
